(19) United States
(12) Patent Application Publication
(10) Pub. No.: US 2017/0235437 A1
(43) Pub. Date: Aug. 17, 2017

(54) TextBack Application

(71) Applicants: Jario Q. Aguilar, Turlock, CA (US); Yessenia D. Panuco, Turlock, CA (US)

(72) Inventors: Jario Q. Aguilar, Turlock, CA (US); Yessenia D. Panuco, Turlock, CA (US)

(21) Appl. No.: 15/044,111

(22) Filed: Feb. 16, 2016

(51) Int. Cl. G06F 3/0482; H04W 4/14; G06F 3/0481; H04W 68/00

(52) U.S. Cl. CPC G06F 3/0482; H04W 68/00; H04W 4/14; G06F 3/04817

(57) ABSTRACT

A method for dynamically presenting highlighted and flagged icons of messages processed on an electronic device is provided. The method comprises: establishing a triggering system of received messages for initiate refreshment of a layout of the icons displayed on a display in the device. After detecting the received messages, creating a ranking of the messages processed by the device utilizing activity logs providing their recent levels of activity. Then the device identifies the most frequently processed messages from the ranking and automatically highlights and flags the message folder and messages refreshing the layout of icons to highlight an icon associated with the most frequently processed messages. The wireless device is required to incorporate modules to perform the method.

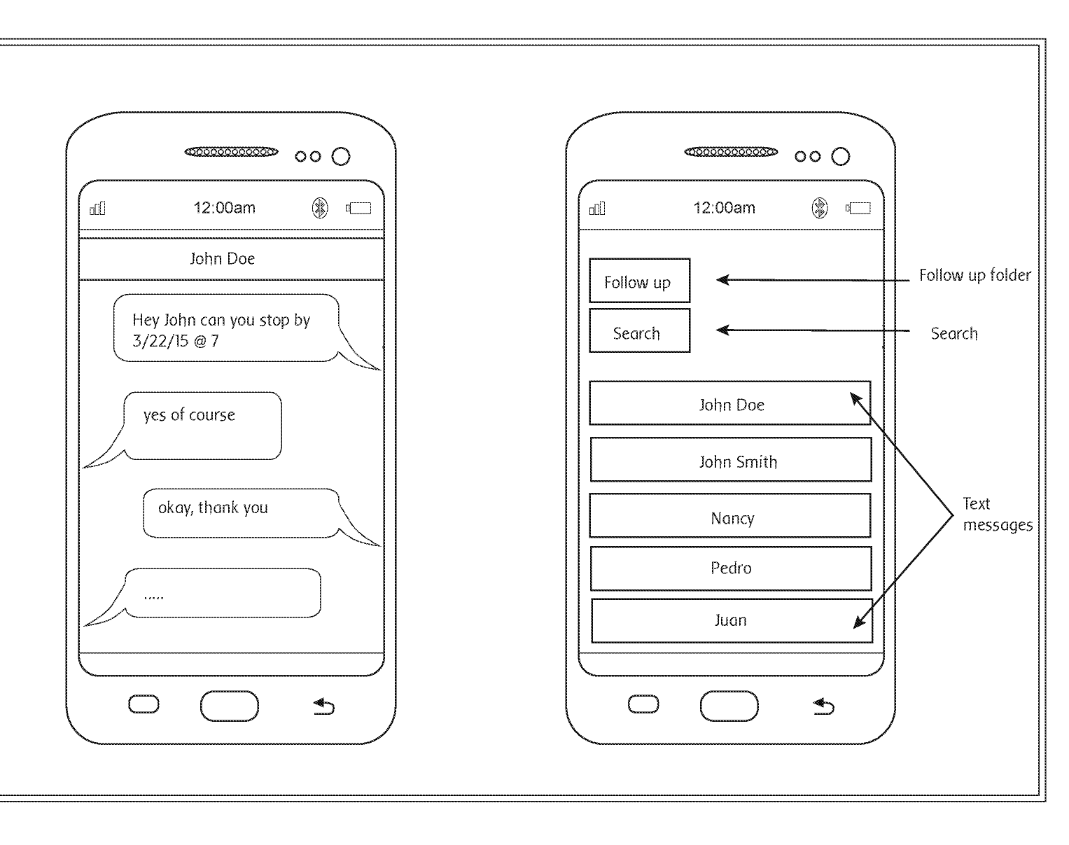

### CROSS REFERENCE TO RELATED APPLICATIONS

Not applicable.

### FEDERALLY SPONSORED RESEARCH & DEVELOPMENT

Not applicable.

### MICROFICHE APPENDIX

Not applicable.

### BACKGROUND OF THE INVENTION

(1) Field of the Invention

The present technology relates generally to communication systems and methods and, in particular, to techniques for flagging or highlighting messages for replying back.

(2) Background of the Invention

As the popularity of message communication has grown, so too has the number of messages received and stored in a user's phone. A mobile phone typically includes all of the messages sent to and from a respective message, address or user name, excluding messages deleted from the account. SMS texting, email, and IM (Instant messaging) are all hugely popular. However, because they are fundamentally symmetric forms of communication, once someone sends you an SMS, for example, the normal way of responding is with a reply SMS.

Often, the user of a mobile communication device receives a message, such as an e-mail, SMS, or a missed telephone call, that needs attention. However, the user cannot always respond at the time the message is received. While the user could remind themselves to respond by creating a task on the mobile device, sending an e-mail as a reminder, creating a calendar appointment, or writing a note on paper, these options are typically inefficient for the user. This is particularly true on mobile devices where text entry is difficult, such as many mobile telephones.

The color used for highlighting text can be important to a user, and most mobile systems permit the user to select the color of the highlighted text. The highlighted text should stand out enough to allow the user to rapidly find the highlighted text on a busy display, yet the highlighted text should not stand out so much that the user's eye is distracted from other display elements that are also important for other tasks. For example, when a large amount of display area is taken up by highlighted text, a vivid highlight color can be too distracting. However, when a single letter is highlighted, a moderate to light highlight color can be too hard to see.

U.S. Pat. No 8,359,014 (Julia) discuses cell phones that have been modified by the addition of software that responds to the pressing of one or more Busy keys that automatically send a pre-typed text message to the sender of the latest text message. The application also includes all other manual commands to launch the SMS service, select the text message to reply to, and send the automated reply message.

US Patent application No 20020187794 (Gideon) disclosed a system that is used for automatically replying, forwarding, filtering, saving, and deleting SMS messages on a wireless handset or alternative SMS enabled device. An SMS Center is used for managing SMS messages, an Auto-Reply Message Server (ARMS) stores Auto-Reply Messages and allows a message receiver to set up, change, or delete Auto-Reply Messages, and an SMS Automatic Handling

Server (SANS) handles message instructions for a message receiver.

In U.S. Patent No. 20100004007 (John Vogel), a method and system are disclosed for providing bidirectional communication between the system and a client device using standard text messaging technologies, such as SMS. Communication may be originated from the client device, or from the system. Users may request specific information from the system using SMS that is delivered to the user through SMS, multimedia messaging services, or email technologies.

A need has arisen for a simple, fast, and safe way for the user of a cell phone who is driving to know what is to be texted back, and, with a single push of a button, send a pre-typed message.

### SUMMARY OF THE INVENTION

According to the present invention, a system and method for enabling improved customized management of SMS messages is provided. This system and method thereby include the functionality of replies, forwarding, filtering, saving, and deleting SMS messages on wireless handsets and other communication devices.

One aspect of the present invention relates to a method and platform whereby software application providers can easily and automatically connect to a platform in order to offer highlighting or flagging the SMS and use of their applications to a global community of mobile phone users through a variety of different mediums, while an individual is not able to reply the messages and chooses to reply later.

The device of this invention includes a software application for reminding by highlighting or flagging the text, SMS, or other messages.

The device is easy to use as this software application highlights the message folder and message in a green and purple color to remind the user to reply.

A further preferred embodiment of the present invention is a system for setting up a plurality of pending replies by users, such that a message receiver can configure the system to respond to specific types of incoming messages in his/her chosen ways.

Another preferred embodiment of the present invention is a system for setting up at least one alternative handling instruction to enable a user to configure the system to respond to incoming messages by filtering, saving, filing, deleting, etc.

Other features and advantages of the present invention will become more apparent from the following detailed description when taken in conjunction with the accompanying drawings, which illustrate, by way of example, the principles of the invention.

### DETAILED DESCRIPTION OF THE INVENTION

The following detailed description refers to the accompanying drawings, which illustrate the embodiments of the present invention. Other embodiments are possible, and modifications may be made to the embodiments without departing from the spirit and scope of the invention. Therefore, the following detailed description is not meant to limit the invention. Rather, the scope of the invention is defined by the appended claims.

The present invention will now be described, where in general it relates to a system that provides bidirectional communication with highlighting features that flag unread messages between the message sender and receiver with standard text messaging technologies. While the following description uses SMS as the text based technology, it is understood that the present invention may be carried out by other text-based technologies in alternative embodiments. It is further understood that the present invention may be embodied in many different forms, and should not be construed as being limited to the embodiments set forth herein. Rather, these embodiments are provided so that this disclosure will be thorough and complete, and will fully convey the invention to those skilled in the art. Indeed, the invention is intended to cover alternatives, modifications, and equivalents of these embodiments, which are included within the scope and spirit of the invention, as defined by the appended claims.

Furthermore, in the following detailed description of the present invention, numerous specific details are set forth in order to provide a thorough understanding of the present invention. However, it will be clear to those of ordinary skill in the art that the present invention may be practiced without such specific details.

In a first aspect, a method of dynamically refreshing the presentation of highlighted and flagged icons for objects stored on an electronic device is provided. An icon displayed on the display screen of the device represents an object processed by the device. A highlighted and flagged icon can contain graphics, text, or a combination of both. An object can be an application, a file, a folder, a data structure, or any other information stored, controlled, or processed by the device.

In the method, the applications may collectively receive and display the communications or messages with sources by utilizing various communication technologies.

In the method, the refreshing of the layout of highlighted and flagged icons may place the icon in a prominent location on the display. The folder of messages is highlighted, and the unread messages are flagged in different colors for reminding the user to text back.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

We claim:

1. A method of providing notification of messages on a wireless communication device having a graphical user interface displayed on the display screen of the wireless communication device comprising of steps:
displaying at least one icon associated with a message application on the graphical user interface of the wireless communication device;
receiving a plurality of messages on the wireless communication device, the plurality of messages including messages; and
in response to a user-activation of the message application associated with the visually modified icon, displaying a dialog box, the dialog box including a plurality of messaging entries, each messaging entry associated with a different colors;

2. The method of claim 1, wherein the plurality of messaging entries are displayed as a vertical listing.

3. The method of claim 1, wherein each messaging entry further displays an associated application service.

4. The method of claim 1, wherein at least one highlighted colored displayed message is an unread message.

5. The method of claim 1, wherein the dialog box displays a maximum predetermined number of messaging entries at one time.

6. The method of claim 5, wherein the maximum predetermined number of messaging entries is user configurable.

7. The method of claim 5, wherein the maximum predetermined number of messaging entries is based upon available screen space.
